(19) United States
(12) Patent Application Publication
(10) Pub. No.: US 2019/0321838 A1
(43) Pub. Date: Oct. 24, 2019

(54) SPRAY GUN

(71) Applicant: SCHIEFFER CO. INTERNATIONAL L.C., Peosta, IA (US)

(72) Inventor: Jeffrey D. THEIS, Dubuque, IA (US)

(21) Appl. No.: 16/385,632

(22) Filed: Apr. 16, 2019

Related U.S. Application Data
(60) Provisional application No. 62/659,959, filed on Apr. 19, 2018.

(51) Int. Cl. B05B 9/01; B05B 12/00; B05B 11/00

(52) U.S. Cl. CPC B05B 9/01; B08B 3/026; B05B 11/3073; B05B 12/0026

(57) ABSTRACT

A hand-held spray gun used for discharging high pressure fluid from a fluid source through a spray wand so as to direct the pressurized fluid in a desired direction. The spray gun has a connector for connection to a hose from the fluid source, which connector can rotate 360° perpendicular to the direction of flow, but the spray wand connected at the discharge end of the spray gun does not rotate.

This application claims priority under 35 USC 119 to Provisional Patent Application Ser. No. 62/659,959 filed Apr. 19, 2018, the contents of which are hereby incorporated by reference.

### FIELD OF INVENTION

The present invention relates generally to the field of liquid and gas conveyance.

### BACKGROUND

Liquids and gases are typically conveyed under pressure through pipes, hoses, manifolds, etc. Along various points of the liquid flow path, the liquid or gaseous media may be metered, controlled, mixed and/or separated along with various other processes. Therefore, it may be necessary to manually divert, stop, or start the flow of such media, and therefore the flow of such media often is controlled by an operator. In many applications, the manual control of such flow is typically carried out by means of a hand-actuated spray handle which contains a valve that is pressed open to initiate flow and automatically closed in the case of desired flow stoppage by the simple release of a trigger mechanism.

Triggered hand-actuated spray handles are known and have been in use for many years as a means of initiating the start and stop of the flow of liquids and gases. Examples of media whereby a hand-actuated spray handle is used include pressurized air, gases and fluids such as high and low pressure water, steam, paint, acid or alkaline solutions, solvents, lubricants, compressed air, fertilizers, herbicides and the mixture or combination of one or more of such media. Known spray handles also are utilized to control media of different temperatures and media in complete or partial liquid or gaseous states. Probably, the most commonly known use of a hand-actuated spray handle is the typical garden hose spray pistol.

In general, the technology of hand-actuated spray handles has remained largely unchanged over the years. The prior art shows multiple configurations, but the basic concept includes a fluid inlet channel or tube whereby the medium passes through to a chamber. Inside the chamber is a normally closed valve where a ball, poppet or other type of sealing surface presses against a mating surface in order to stop and seal off the medium flow through the chamber. The ball or mating surface of the valve is usually held in place by one or more internal or external springs so as to keep the medium from passing through the chamber. The position of the valve is normally closed. When it is desired to open the valve to initiate flow through the chamber to another channel known as the outlet, a trigger mechanism is pulled or pushed by hand. This manually applied force overcomes the spring tension so as to open the valve by moving and unsealing the ball or poppet from the seat, thus allowing the medium to flow through to the outlet channel and further downstream. Eventually, the flowing medium may exit to the atmosphere, as in the case of a spray application, or the flowing medium may deposit a predetermined dose of material, or may simply recirculate the medium through a desired path. When the trigger is manually released, the valve automatically goes back to the normally closed position, thereby stopping the flow of the medium through the device.

The applications for media to be used with a trigger actuated valve are virtually unlimited. Simple examples of such devices are water spray devices that are used for general cleaning and/or gardening. Other, more demanding applications have evolved in higher pressure applications, such as those using hot or cold water under high pressure.

Mayer U.S. Pat. No. 2,208,850 is an early example of a hose connected valve with a hand actuated trigger mechanism. The pressurized hose connection is made in line with the valve mechanism and the hose serves a second purpose as a handle. For purposes of clarifying the present invention, this configuration is referred to herein as an “in-line” trigger device.

Rinkewich U.S. Pat. No. 2,937,813 is an early example of a hose connected valve with a trigger mechanism. In Rinkewich, a trigger is pushed, rather than pulled, and the pressurized hose connects into the bottom of the handle which is configured as a tube. For purposes of clarifying the present invention, this device is referred to herein as a “back-entry” trigger device.

U.S. Pat. No. 5,176,327, Peterson et al. also discloses a “back-entry” device with a trigger leverage point where the strongest fingers, i.e. forefinger and middle finger, are at the easiest point of leverage of the trigger that requires the least amount of force.

Another spray gun with back-entry trigger device is Suttner U.S. Pat. No. 5,118,080. This back-entry gun uses two spring loaded pins whereby one pin goes slightly over center as the trigger is pulled and the valve is opened. It then rests in a fixed point and the pins hold the trigger in place after it is pulled. This design requires very minimal finger tension to hold the trigger open, yet the spring inside the valve provides enough force for the trigger to close safely once it is released.

Tanner U.S. Published Patent Application 2007/0228190A1 is an example of a hose connected valve with a trigger mechanism. The fluid connection to the device is made via a high pressure tube that runs inside a handle-shaped plastic housing. This pressurized hose connection is through the bottom of the gun handle. For purposes of clarifying the present invention, this device is also a “back-entry” trigger device.

Breuer et al. U.S. Publication No. 2016/0288148A1, demonstrates an ergonomic improvement over other prior art devices in that there are two mechanisms that have to be actuated to open the gun. Once opened, the thrust from the exiting water jet provides enough force for the second mechanism to remain pressed into the palm of the hand. This keeps the gun open without having to hold any kind of trigger mechanism open by tension on the operator's fingers.

DeWall U.S. Pat. No. 7,516,910 is an example of a hose connected valve with a trigger mechanism. The pressurized hose connection is made directly to the valve in front of the trigger mechanism. For the purposes of clarifying the present invention, this device is referred to hereinafter as a “bottom-front entry” trigger device.

Winkler EP Application 1516674A2 discloses another bottom-front-entry trigger device with the unique feature that the pressurized connection from the hose is made at the front of the spray gun. The pressurized connection and the outlet are contained in the front of the spray gun which swivels 360° perpendicular to the direction of the fluid flow.

So called in-line, back-entry and bottom-front entry devices are traditional forms of hand-actuated spray devices. However, they each have their limitations and are not desirable in a number of cases. For the purposes of describing the invention, the device of the invention will be a device for high pressure cleaning with hot water. It is common to see high pressure water applications where the pressures often exceed 3,000, 4,000 or even close to 5,000 PSI. Temperatures with such devices can exceed 250° F. These ratings are not limitations of the present invention. They are just examples of particular applications for high temperature, high pressure devices. In-line trigger devices, such as Mayer, are not practical in such applications due to the possibility of burns to human tissue caused by heat transfer through the pressurized connector hose. Additionally, the hose serving as a handle represents another hazard if the hose or actuation valve develops a leak. Such leaks at high pressure and temperature are known to cause traumatic injury to the user.

Back-entry trigger devices, such as Rinkewich, mitigate the potential of a traumatic injury due to high pressure by eliminating the dual purpose hose handle, but a back-entry device does nothing to mitigate the high water temperature being transferred quickly to the hand, which is still a likely cause for burns.

The back-entry device of Tanner mitigates the traumatic injury potential by eliminating the hose handle of Mayer because the entry tube is housed within a plastic structure. Such a structure may mitigate the potential of burns since the plastic housing serves as an insulator between the inlet tube and the human hand. While the potential for a burn may be eliminated, the high temperature may make use of the Tanner type device uncomfortable because the heat will still transfer to the outer surface of the handle over time.

A bottom-front entry device, such as DeWall, mitigates both concerns about the high pressure and the high temperature exposure to the user. This is because the connection is made to the front bottom portion of the trigger mechanism and not through the handle portion. Therefore, the heat does not transfer to the hand grip area and the hose connection is not located in direct contact with the hand.

Many of the known hand-trigger actuated spray handle devices, whether connected in-line, back-entry or bottom-front-entry, are fed through a hose entering from behind or below the handle and beneath the user of the device. Such connection are problematic, especially in an application such as high pressure cleaning of vehicles or surfaces when the hose drops below as it finds its way back to the source of water or pump. Due to rear entry of the hose into the gun, the hose must come from below, requiring a longer hose. Also, the hose is likely to come into contact with the vehicle where it can cause scratching and the additional length represents a trip hazard Thus, the hose restricts freedom of movement of the operator and the trigger actuated spray device resulting in the hose being dragged along the ground. This can cause abrasion of the hose, and when pulling the hose, there is constant pressure on and twisting of the hose connection. Also, because the hose is out of the line of sight, this presents a trip hazard to the user.

Front-entry device Winkler mitigates the concern of restricted freedom of movement caused by a hose below the spray gun because the pressurized connection from the hose swivels 360° perpendicular to the fluid flow at the outlet, allowing for an optionally aerially-positioned hose to alleviate trip hazards and hose wear from dragging on the ground. The front of the gun, which contains both the pressurized connection from the hose and the fluid outlet, swivels 360° perpendicular to the fluid flow. But because the fluid outlet swivels with the pressurized connection from the hose there may be undesirable changes to spray angles and spray consistency.

### SUMMARY OF THE INVENTION

The present invention addresses the limitations of known hand-actuated trigger spray devices. Typically, when used in cleaning applications, the last several inches or so on the nozzle end of the barrel is a spray wand which is often bent at an approximate 20 or 30 degree angle to the barrel to facilitate its use in the cleaning application. In the device of the invention, the pressurized hose connection is made in a unique way at the front of the spray gun. A swivel connection with the hose serves as the inlet of the spray gun, and the connection swivels 360° perpendicular to the direction of flow through the barrel, but the spray wand at the nozzle end of the barrel does not rotate. In other words, the spray wand does not rotate when the hose connection does. With known prior art devices, when the hose connection is rotated, the spray wand rotates at the same time. Therefore, when the operator wants to orient the hose position, it cannot be done without rotating the wand which then changes the angle at which the wand is oriented. The discharge of the pressurized fluid in that situation is then changed, which means the operator must somehow reconfigure the wand in a separate step. This is important because if that step is not taken, the discharge of the spray is at the wrong angle which can cause undesired impact of the pressurized fluid with the objects being cleaned or painted. The design of the invention allows the spray gun hose connection to be moved for comfort or ease of use, but the spray wand is always consistently oriented, preventing potential damage to the object being cleaned or painted. Since the pressurized hose connection swivels but the fluid outlet remains static, this provides for consistency in spray angle without additional adjustment by the operator. Also, since the swivel hose connection is rotatable through 360° and the spray wand attached to the barrel does not rotate with the swivel connection, desired movement of the spray wand can be accomplished by the intentional rotation of the spray gun handle while the connected hose is held in the same position. Thus, desired reorientation of the spray wand does not require movement of the pressurized hose as with all prior art devices.

The prior art also teaches that a certain amount of resistance is required to rotate the spray gun connection at the swivel. This is intentionally done in order to keep the hose in a desired position until manually rotated to another position. Prior art designs are such that the entire valve housing (usually made of brass) spins within a plastic sleeve. But the sleeve is not sealed against the elements allowing dust, dirt, sand, chemicals, etc. to deposit between the housing and the sleeve, which can result in wear over time which produces undesirable loosening of the swivel surfaces causing buildup of debris between the surfaces resulting in the swivel locking up. In the present invention, the inlet and outlet of the valve housing run substantially parallel to each other which allows the swivel to be completely sealed against outside elements, thus preventing contamination and wear. The parallel channels may be sufficiently long to allow the hose connection to be placed forward, with the hose connection equipped with a handle allowing for greater maneuverability of the spray gun. Also, the swivel can be equipped with a method for fixing it in a particular position. Such position fixing can be permanent or changeable.

In one embodiment of the invention, the pressurized hose is connected at the front and top of the spray gun and the hose can be suspended from above by means of a spring loaded boom. The hose is not in contact with the ground and therefore will not abrade. The hose is connected from above and, because the connection is a unique swivel, the freedom of movement eliminates twisting action and stress on the hose connection and the user. Because the pressurized hose connection is suspended, the trip hazard is completely eliminated. Furthermore, the pressurized connection swivels but the fluid outlet remains static, allowing for consistency in spray angle without additional adjustment. This eliminates all limitations of the prior art.

Prior art teaches positioning the trigger such that the strongest fingers, the forefinger and middle finger, are at the easiest points of leverage to lessen user fatigue. In the present invention, the spray gun may be oriented to allow for a user's strongest fingers to be at the easiest points of leverage. The user need not adjust his or her grip when there is a change in hose position because the swivel connector allows for 360° rotation of the pressurized connection of the hose.

The hose connection may be designed so that the torque necessary to rotate the swivel may be constant, more or less or variable.

### DESCRIPTION OF THE DRAWINGS

FIG. 1 is a side elevational view of the spray device of the invention;

FIG. 2 is an end elevational view of the front end of the spray device;

FIG. 3 is an exploded side view showing the major components of the spray device;

FIGS. 4A-4D are front views of the swivel connector on the barrel at different swivel points around the barrel;

FIG. 5 is a side view of the spray device with one side removed and some components removed to show other interior components;

FIG. 6 is another side view of the spray device with one side removed to show the interior components;

FIG. 7 is another side view of the spray device with one side removed to more clearly show some of the working parts; and

FIG. 8 is a perspective view of the assembled spray device of the invention.

### DETAILED DESCRIPTION OF THE EMBODIMENTS OF THE INVENTION

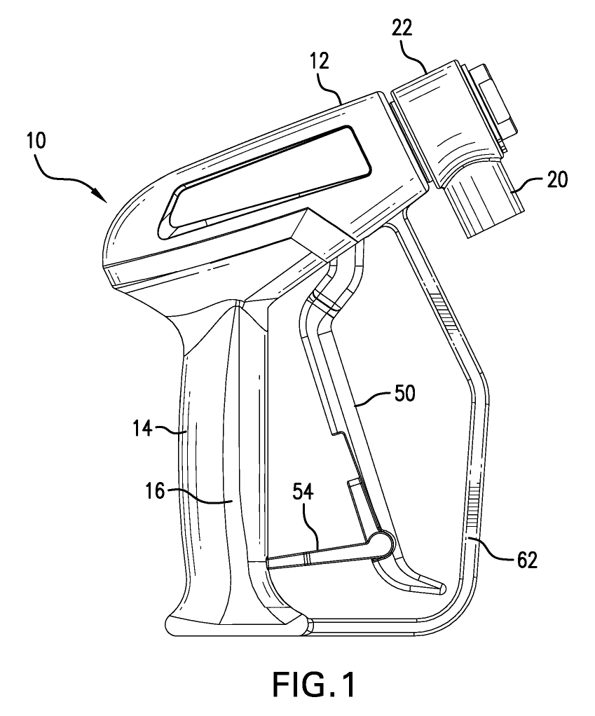

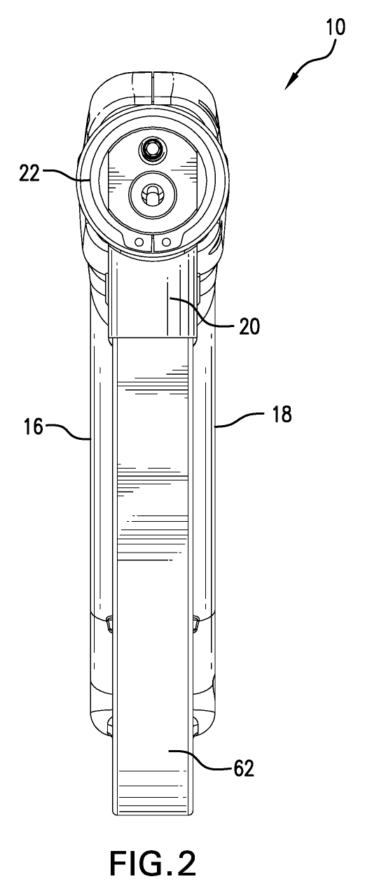

Referring now more particularly to the drawings, there is shown a hand held, trigger-actuated spray device or gun 10 adapted for controlling and directing high pressure fluid streams. FIG. 1 shows a spray gun 10 with a pistol-configured body or housing having a barrel 12 and a depending handle 14 disposed at an angle to the barrel 12. As shown in FIG. 2, the housing is formed by right and left hand housing sections 16 and 18, respectively, which are secured together in any suitable manner, as is well known to those skilled in the art. A fluid supply line (not shown) is connected to an adapter fitting 20 that is a part of a swivel connector 22 attached to the discharge end of the barrel 12 for supplying pressurized fluid to the spray gun 10. For example, the pressurized fluid may be supplied from a liquid pressure washer or other high pressure fluid supply source.

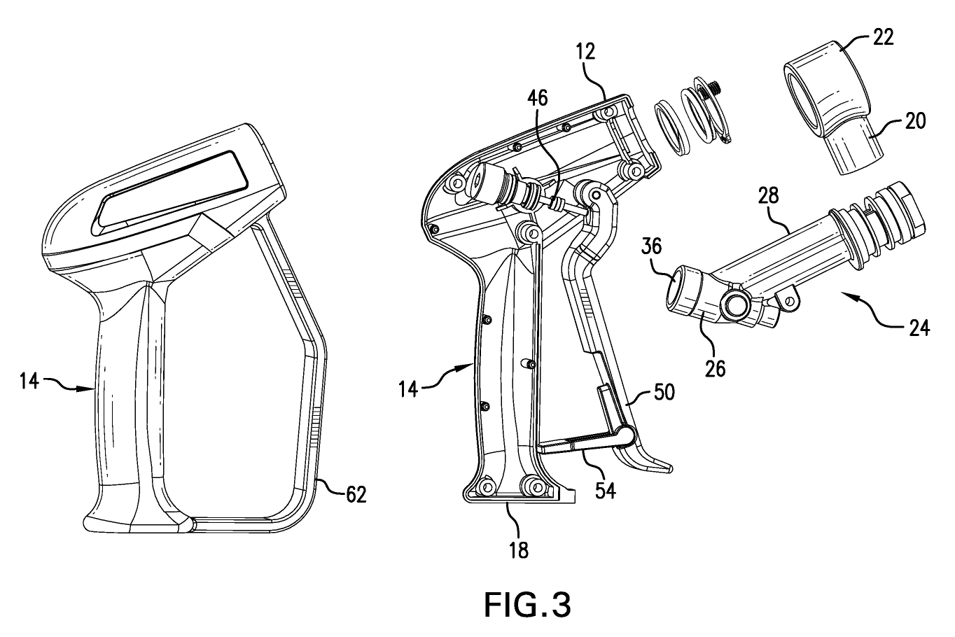

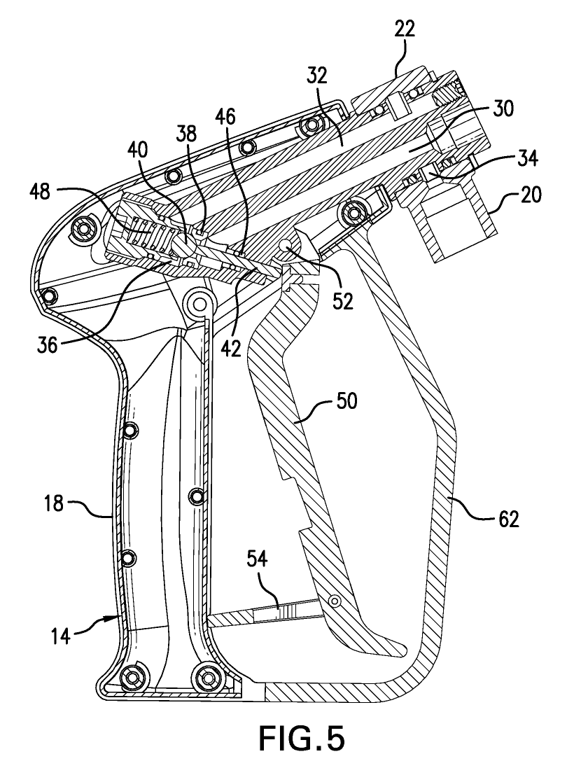

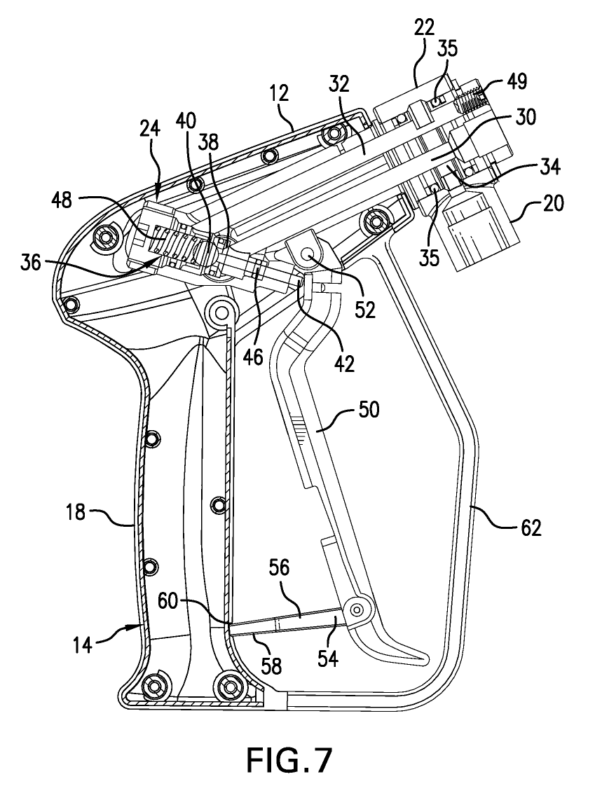

As best seen in FIGS. 3, and 5-7, for controlling the flow of pressurized fluid to and through the spray gun 10, a trigger actuated operating assembly 24 is supported within the housing sections 16 and 18. The assembly 24 includes a valve portion 26 and a forward extending portion 28 that has an internal inlet passageway 30 and a discharge passageway 32 that are substantially parallel to each other. (See FIGS. 5, 7). At the outer end of the assembly 24 is an annular inlet port 34 that together with the swivel connector 22 provide for flow of fluid from the supply source through the adapter fitting 20 into the inlet passageway 30. Swivel connecter 22 is sealed from outside elements by a pair of seals, such as O-rings 35, which allow the swivel connector 22 to move 360° around the end of the barrel 12. Contained within the valve portion 26 are a valve chamber 36 and a valve seat 38 at the inlet end of the valve chamber 36. Extending and moveable within the valve chamber 36 is a ball-shaped valve 40 that is operatively connected to and selectively moved by a valve stem 42. The valve 40 and stem 42 may be separate members or one piece. Valve stem 42 extends through an axial bore in the valve seat 38, and the outer end of the valve stem 42 is maintained along an axial line by extending through the bore of an annular guide member 46 held in place by the valve portion 26 of the assembly 24. A valve seat retaining spring 48 biases the valve 40 normally onto the valve seat 38 in a position closing off the flow of fluid from the inlet passageway 30. When the valve 40 is moved from the valve seat 38 by actuation of the valve stem 42, fluid in the inlet passageway 30 will flow into the valve chamber 36 and then into the discharge passageway 32 from where it will be discharged from the spray gun. The outer end of the assembly 24 has a connector, such as threaded member 49, to provide for connection of an appropriate spray wand or nozzle (not shown) to the discharge passageway 32 for directing the discharged fluid in a desired direction and/or pattern, as is well known to those skilled in the art.

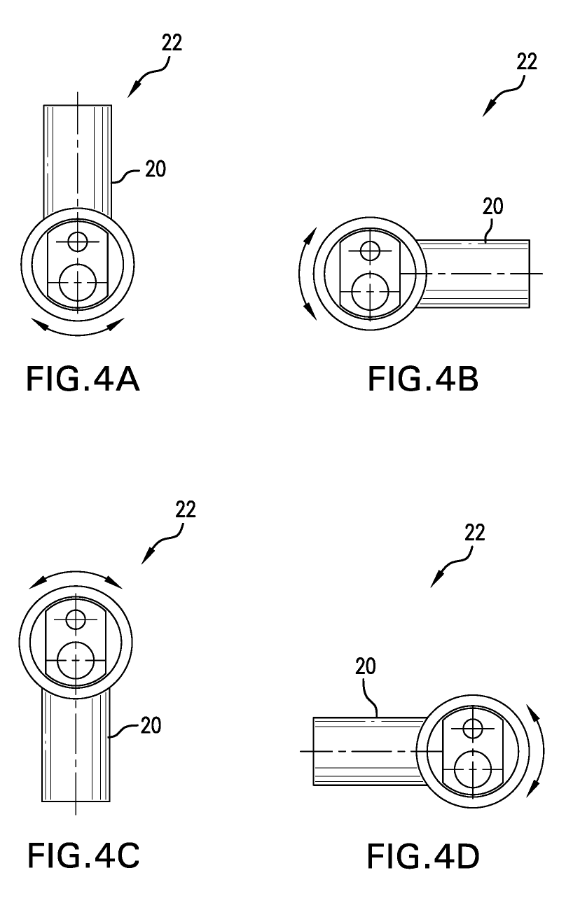

As shown in FIGS. 4A-4D, the swivel connector 22 which is movable 360° around the end of the barrel 12. The swivel connector 22 is shown from an end view, at different points around the barrel 12.

As best seen in FIG. 7, a trigger 50 is pivotally mounted on a pivot pin 52 that is secured at the lower end of the barrel 12. Trigger 50 extends downwardly adjacent to the handle 14 so that it can be gripped by the fingers of a user's hand. Trigger 50 engages the outer end of the valve stem 42 so as to move the valve 40 between its normally closed position seated on the valve seat 38 and an open position that provides for the flow of high pressure fluid from the inlet passageway 30 through the valve chamber 36 and into the discharge passageway 32 Upon release of the trigger 50 by the user, the valve seat retaining spring 48 will exert pressure against the valve ball 40 to move it into engagement with the valve seat 38 while the valve stem 42 moves the trigger 50 away from the handle 14

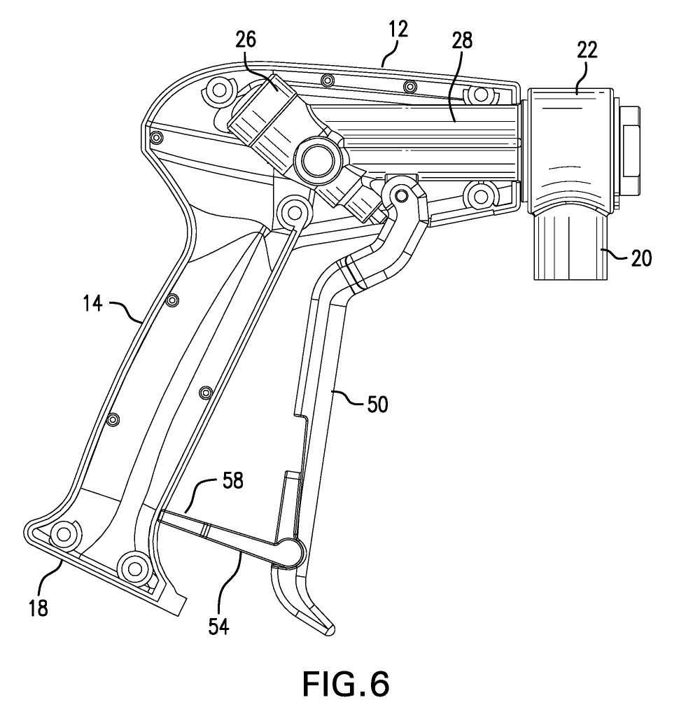

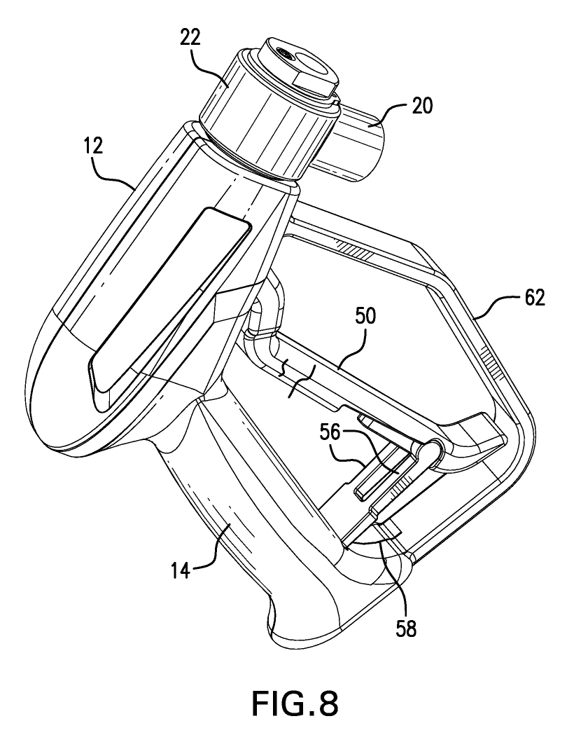

Preferably, the spray gun has a trigger lock 54 that is adapted for easy and reliable operation for preventing unintended and potentially dangerous discharge of high pressure fluid from the spray gun. As best seen in FIG. 8, the trigger lock 54 has bifurcated arms 56 pivotally mounted on the inside of the trigger 50, the arms 56 terminating in a stop member 58 that is engageable in a slot 60 (FIG. 6) formed in the front edge of handle 14. When it is desired to use the spray gun, the user's fingers can easily unlock the trigger by moving the trigger lock 54 upwardly. Then, to lock the trigger 50, the user can move the lock 54 downwardly until the stop member 58 is engaged in the slot 60. The trigger 50 is further protected from inadvertent actuation by a trigger guard 62 that extends from the bottom of the barrel 12 downwardly and rearwardly where it is permanently joined to the lower end of the handle 14.

The present invention is not limited by the embodiments or examples described herein. The terms and expressions which have been used are used as terms of description and not of limitation and there is no intention in the use of such terms and expressions of excluding any equivalents of any of the features described, or portions thereof, but it is recognized that various modifications are possible within the scope of the invention.

1. A spray gun for dispensing a pressurized fluid from a supply source through a spray wand, the spray gun comprising:
a body including a barrel and a handle, the handle being disposed at an angle from the barrel and the barrel having a discharge end from which fluid is dispensed from the spray gun;
a swivel connector connectable to a fluid supply and combined with the barrel near the discharge end of the barrel to provide an internal fluid flow path with the barrel, the swivel connector being independently rotatable relative to the barrel;
the barrel having an inlet passageway and a discharge passageway, the inlet passageway being in fluid communication with fluid supplied through the internal fluid flow path provided by the swivel connector;
a valve in the barrel for controlling fluid flow between the inlet and discharge passageways; and
a trigger combined with the handle and operatively combined with the valve in the barrel to selectively control fluid flow between the inlet and discharge passageways, thereby providing for controlled discharge of fluid from the discharge end of the spray gun through a spray wand.

2. The spray gun of claim 1, wherein the swivel connector is independently moveable circumferentially 360° relative to the barrel.

3. The spray gun of claim 1, wherein the internal fluid flow path provided by the swivel connector and barrel is sealed from outside elements by a seal.

4. The spray gun of claim 1, wherein the discharge end of the barrel has a connection for receiving an appropriate spray wand.

5. The spray gun of claim 1 further comprising:
a valve seat in the barrel, wherein the valve is located in the valve seat;
a retainer for normally holding the valve in a position to stop flow between the inlet and discharge passageways; and
a valve stem combined with the valve and the trigger to selectively move the valve from the valve seat in response to movement of the trigger, wherein the valve is movable against a biasing force of the retainer in response to a movement of the trigger.

6. The spray gun of claim 5, wherein the retainer is a retaining spring.

7. The spray gun of claim 5, wherein the valve is a ball-shaped valve.

8. The spray gun of claim 1, wherein the internal inlet passageway and the discharge passageway inside the barrel are substantially parallel.

9. The spray gun of claim 1, further comprising:
a trigger lock combined with the trigger, the trigger lock having bifurcated arms pivotally mounted on the trigger;
the handle having a slot to receive the trigger lock; and
a stop member in the slot, wherein the bifurcated arms are engageable with the stop member to lock the trigger.

10. The spray gun of claim 1, further comprising a trigger guard that extends from the barrel to the handle to create an open space, the trigger being positioned in the open space.
